(19) United States
(12) Patent Application Publication
(10) Pub. No.: US 2008/0307682 A1
(43) Pub. Date: Dec. 18, 2008

(54) In-store merchandising system and method

(76) Inventors: Peter Robert Foley, Cincinnati, OH (US); Craig Burton Wynett, New Richmond, OH (US); Darrell Lee Mann, Clevedon (GB)

Correspondence Address: THE PROCTER & GAMBLE COMPANY;Global Legal Department - IP, Sycamore Building - 4th Floor, 299 East Sixth Street, CINCINNATI, OH, 45202, US

(21) Appl. No.: 11/820,098

(22) Filed: Jun. 18, 2007

(51) Int. Cl. G09F 1/08; E04H 3/00

(52) U.S. Cl. 40/538; 186/52

(57) ABSTRACT

A system and method for merchandising a product or service. The system comprises a first perceived-as-three-dimensional image. The image comprises a directional preference and an indicia associated with the product or service. The system also comprises a display element associated with the product or service disposed at a first position upon a displaying element. The directional preference of the first perceived-as-three dimensional image relates to the location of the display element upon the displaying element.

### FIELD OF THE INVENTION

The disclosure relates to the field of product merchandising. The disclosure relates particularly to the field of in-store product merchandising.

### BACKGROUND OF THE INVENTION

One challenge facing marketers in retail environments is capturing and directing the attention of a shopper. The desire of the manufacturer may be to direct the shopper to a particular portion of a retail display where the marketer's product or information relating to a particular product or service is displayed. This challenge exists for both new and existing products. What is desired is a system and method for capturing the attention of a shopper and directing the captured attention to a particular display area in a retail environment.

### SUMMARY OF THE INVENTION

In one aspect the invention comprises a system for the merchandising of a product or service is disclosed. The system comprises a first perceived-as-three-dimensional image. The first image comprises a directional preference and indicia. The indicia is associated with the product or service. The indicia is disposed upon a floor surface. The system further comprises a display element associated with the product or service disposed at a first position upon a displaying element. The directional preference of the first perceived-as-three dimensional image relates to the location of the display element upon the displaying element.

In another aspect, the invention comprises a method for merchandising a product or service. The method comprises displaying a perceived-as-three-dimensional image is displayed upon a floor surface of a merchandising area. The image comprises a directional preference. A display element associated with the product or service is disposed at a first location upon a displaying element. The displaying element is disposed at a location related to the directional preference. At least a portion of the image is associated with the product or service or with an attribute of the product of the product or service.

### BRIEF DESCRIPTION OF THE DRAWINGS

The FIGURE schematically illustrates one embodiment of the kit of the invention in use as a merchandising system.

### DETAILED DESCRIPTION OF THE INVENTION

As used herein, conditionally provided means an item is made available to a shopper upon the satisfaction of particular conditions. Exemplary conditions include, the purchase of a product or service, the submission of a requisite number of proofs of purchase of a product or service, the completion of a survey, navigating to a particular internet address, and providing information via written or electronic means.

As used herein, a directional preference means any aspect or combination of aspects of an image which converge in a particular direction. A directional preference may shift the focus of a viewer of the image toward the direction of convergence.

As used herein, a display element means any element relating to a purchasable product or service which may be displayed in a merchandising environment. Exemplary display elements include, products, placeholder cards for large products or services, sales literature, additional images relating to a product or service.

As used herein, displaying element means any element used for the purpose of holding or supporting display elements. Examples of displaying elements include shelving systems, racks, rotating display, and display screens.

As used herein, indicia mean any element of an image. Indicia may be created by printing, embossing, weaving or other methods known in the art for creating visual elements.

As used herein, merchandising environment means any location where marketing elements are utilized singly, or in combination, for the purpose of encouraging the purchase of products and/or services by one or shoppers.

As used herein, perceived-as-three-dimensional means an image which, through the use of shading, perspective, perceptional biases, and other methods as are known in the art of visual illusion, may be perceived by a viewer of the image as conveying a three dimensional nature which is not present.

The perceived as three dimensional images of the invention may utilize a number of perceptional elements to accomplish the illusion. The ratio of the illusions width to its length can be varied to emphasize a local point in the environment for the observers focus.

As used herein, viewer orientation means a field of view available to a viewer located at a particular orientation with respect to an image and viewing an image from within a particular range of directions.

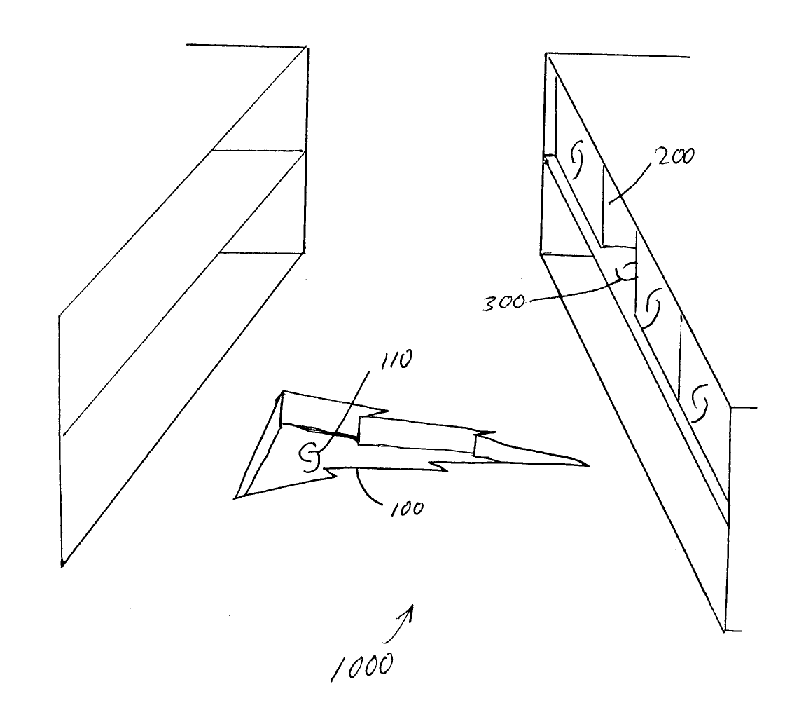

As illustrated in FIG. 1, a kit 1000 comprises a first perceived-as-three dimensional image 100, and a display element 200 associated with a product or service. The first image 100 comprises a directional preference and indicia associated with the product or service.

The directional preference may be explicit as in an arrow, a pointing hand, or any pointer shape having a clearly defined indication of direction. The directional preference may be implicit by the use of an element having a known directional bias such as any item having a recognized front end and trailing end. Exemplary items include, modes of transportation, indications of natural motion, animal portrayals, and anthropomorphic portrayals. Modes of transportation may include such as automobiles, airplanes, bicycles, trains, and similar conveyances having a clearly recognized direction of travel that may be used to suggest a change for the viewers focus. Natural motions may include flowing air or water. Animal and anthropomorphic representations include both realistic and stylized representations of humans and animals having well recognized leading and trailing aspects to indicate a desired direction of focus.

The first image 100 may also include more subtle indications of a desired direction such as a convergence of the image in the desired direction. As the image is perceived as three dimensional, the directional preference may be implicit in the shape of the three dimensional appearance of the image. As an example, the image may appear to be a hole or a bump in the observed surface, the shape of the hole or bump providing the direction preference of the image as in an arrow or converging shape.

The first image 100 also comprises an indicia 110 related to the subject product or service of the merchandising effort focus of the kit. The indicia 110 may comprise information relating to the product or service such as the brand name of the product or service, all or a portion of the on-shelf package appearance of the product, the nature of a benefit of the product or service, including information relating to product flavors, scents, performance and other known product attributes. The indicia 110 may comprise information relating to the relationship of a particular service to a product indicated by the directional preference. As an example, the image 100 may be used to inform a shopper that installation services may be available to coincide with the purchase of a displayed item. The colors utilized in the image 100 and the indicia 110 may be similar to, suggestive or in contrast to those colors utilized in the display and marketing of the product or service.

The indicia 110 may appear as a two dimensional aspect of the perceived as three dimensional image or as a perceived as three dimensional aspect of the image 100. In one embodiment the indicia appears as a perceived as three dimensional package similar to the product package on the shelf. In one embodiment the indicia appears as a two dimensional representation of a portion of the brand imagery affixed to a perceived as three dimensional aspect of the image, such as a brand associated image and brand name appearing to lie in the bottom of a perceived hole in the observed surface.

The kit 1000 also comprises a display element 200 associated with the product or service. In one embodiment the display element 200 is the product and associated product packaging as offered for purchase on product shelving. In this embodiment, the first image 100 may be used to direct the focus of attention of a shopper in the merchandising environment to the portion of the product shelving where the packaged product associated with the image is present.

In one embodiment the display element may be related to the product as a place holder for products which, for example, are too large for on shelf display or which conditionally available to shoppers for regulatory reasons, as an example, certain over the counter pharmaceutical products, alcohol and tobacco products and other products whose availability is restricted or controlled.

In one embodiment the first image may be perceived to lie below the plane of the observed surface and be perceived as a hole or depression or object lying beneath the surface. The image may alternatively be perceived as floating above the observed surface. The image may also be perceived as transitioning and comprising aspects, below, in and above the observed surface. As an example, the image may comprise an arrow which appears to be angled from appoint beneath an observed floor surface to a point above the observed surface such that the apparent direction of the arrow points to the display element present upon a shelf.

The kit 1000 may further comprise a second image 300 associated with the product or service. The second image may be disposed upon the display element or upon the displaying element supporting the display element. The second image 300 may be two dimensional or perceived as three dimensional in nature. The second image 300 may be similar or dissimilar to the first image 100. In one embodiment, the second image 300 is disposed at a location corresponding to a predetermined location for placement of the display element 200. In this embodiment, the display element 200 occludes observation of the second image 300 until removal of the display element 200 from the predetermined location reveals the second image 300.

The kit 1000 may additionally comprise a third image associated with the product or service. The third image may be conditionally provided to a purchaser of the product or service as an incentive to a single purchase or as a reward for a series of purchases. The third image may be conditionally provided in a form intended for ongoing display by the recipient in their home, work transportation or other environment. The third image may be provided with a means to enable attachment to a surface to facilitate viewing the image. Such means may include, magnetic backing material or separately provided adhesive backed magnetic material, adhesive material, or provision of the image upon self adhesive film for releasable attachment to desired surfaces for easy viewing of the image.

The kit 1000 may comprise an image system wherein the first image is coupled to a fourth image such that the first image may be observed from a first viewer orientation and the fourth image may be viewed from a second viewer orientation where the first and second viewer orientations are angularly separated. The angular separation of the first and fourth viewer orientations may be associated with the specific details of the merchandising environment. As an example, the first viewer orientation may be that of a viewer proceeding along a store aisle in a first direction. The second viewer orientation may be that of a viewer proceeding along the same aisle but in the opposite direction. Using lenticular printing techniques and other printing methods as are known in the printing arts, the first image may be visible from the first but not the second viewer orientation while the fourth image may be visible from the second but not the first viewer orientation. The fourth image may be perceived as three dimensional and may also be related to the product or service or may be unrelated to the product or service and/or may be other than perceived as three dimensional.

The kit 1000 may utilized as at least a portion of an in-store merchandising system. In a system, the first image may be disposed upon a floor surface in a merchandising environment. The first image may be a printed image on film or other suitable backing material to allow adequate adhesion to the observed surface. The first image may be a projected image where a display device is built into the observed surface and the first image is subsequently displayed upon the device.

In a system, the display element may be disposed upon a displaying element in an area related to the directional preference of the first image. The displaying element may be any known merchandising display apparatus as such apparatus are known in the art of product merchandising.

The disclosed system may include, either as an addition or as a separate version of the system, an active on-shelf shopper interaction system. An example of such a system includes one or more shopper presence sensors configured to detect the presence of a shopper in the merchandising environment near the targeted portion of the displaying element. Such a shopper detection sensor may comprise an ultrasonic, electromagnetic, including visible, infra red radio frequency, microwave and other electromagnetic energy based sensors force, induction or other known sensors for detecting the presence of a shopper directly or indirectly via the presence of a shopping cart.

The system may also include one or more control elements receiving information from the shopper presence sensor relating to the presence of a shopper, and controlling one or more output relays to provide power to an on-shelf display. The on-shelf display may comprise a power distribution element. An exemplary power distribution element may be provided as a shelf mat having positive and negative electrodes positioned at locations corresponding to placement positions for display elements for the product or service.

The display element may comprise one or more packages comprising electroluminescent elements visible from the exterior of the package, power pickup areas configured on the bottom or other surface of the display element package and arranged to correspond to the positive and negative electrodes present in the power distribution grid. The electroluminescent elements and power pickup areas may comprise a portion of the display element label or be integral to the display element package.

In one embodiment the power pickup areas may be smaller than the electrodes of the power distribution grid but may be spaced with about the same center to center spacing. This configuration may reduce the precision needed in placing the display elements upon the power distribution grid to enable the operation of the system.

In one embodiment, power in the power distribution grid may be used to generate electromagnetic fields from one or more filed coils. In this embodiment, the display elements may comprise a corresponding field coil for the purpose of reacting to the electromagnetic field by generating an induced electric current which may be used to power the electroluminescent aspects of the display element.

The controller may provide power to the power distribution grid in response to an input from a sensor. During the time that power is provided, the electroluminescent portions of the properly placed display elements may illuminate highlighting the presence of the display elements upon the shelf or drawing additional attention to particular aspects of the display elements associated with the electroluminescent elements.

In one embodiment the power distribution grid provides power to at least one product package disposed upon the power distribution grid. An electroluminescent element of the product package illuminates due to the power transfer. After a predetermined interval, the controller provides a second output to the power distribution grid enabling the transfer of power from the grids to a second portion of the package. This secondary transfer of power enables the illumination of a second electroluminescent element of the package. The respective electroluminescent elements may be used to communicate different aspects of the product to the shopper. The first illuminated element communicates the brand name of the product while the second element communicates a product performance attribute such as cleaning or whitening capability.

In one embodiment the controller may provide an output profile to the power distribution grid such that respective elements are turned on and off at predetermined times and in a predetermined sequence to convey particular aspects related to the product to the shopper. The controller may be configured to maintain power to the power distribution grid for a preset time period upon the detection of a shopper, or may be configured to maintain power for as long as a shopper is detected. In one embodiment the controller may be configured to cycle power during a particular interval associated with the detection of a shopper to cause the electroluminescent elements to cycle on and off to draw more of the shoppers focus to the area. The active shelf display system may be used in conjunction with the perceived as three dimensional image by using each to focus the attention of the shopper to the same portion of a shelf display. The two aspects may be linked by placing the shopper presence sensor such that the target sensing area corresponds to a viewing area calculated to have a high likelihood of stopping the motion of a shopper due to the perceived-as-three dimensional image. In this manner, the shopper may proceed through the environment, upon perceiving the illusion of the first image the shopper may pause their motion trigger and output from the shopper sensor and activate the electroluminescent aspects of the display elements such that as their focus is directed to the display elements, the elements light up. The shopper may remove one or more of the display elements for purchasing and may thereby reveal an additional image incorporated into the power distribution grid/shelf mat. This image may also be associated with the product or service.

In one embodiment the shopper sensor may be a pressure activated switch incorporated into the first image and disposed upon the floor of the environment such that in response to the illusion the shopper steps upon, or rolls their cart upon the switch and thereby activates the on-shelf display.

The merchandising system may be expanded by the addition of end of aisle display, store front cues, informational postings provided by in-store and at home television broadcasts, radio, internet, print and other advertising means as these are known in the art. Any and/or all may at least partially be used to raise the interest or awareness of potential shoppers with respect to the presence of the disclosed merchandising system.

### EXAMPLE 1

In one embodiment a floor display designed to be perceived as an arrow shaped hole in the floor is disposed upon the floor of a retail outlet. The perceived direction of the arrow points to either the left or the right depending upon the direction of the viewers approach. The floor display is disposed adjacent to a shelving system. Product packages of a particular brand are disposed upon the shelving system. The direction of the arrow points to the shelving system. The floor display comprises an indicia which relates to the displayed product packages and/or the brand.

### EXAMPLE 2

In one embodiment a floor display designed to be perceived as an arrow floating above the floor. The arrow is perceived to point to the display shelves on one side of the aisle. A shopper sensor detects the presence of a shopper and provides an output to a controller. The controller provides an output to a power distribution grid disposed upon at least one shelf. The power distribution grid provides power to at least one product package disposed upon the power distribution grid. An electroluminescent element of the product package illuminates due to the power transfer. After a predetermined interval, the controller provides a second output to the power distribution grid enabling the transfer of power from the grids to a second portion of the package. This secondary transfer of power enables the illumination of a second electroluminescent element of the package. The respective electroluminescent elements may be used to communicate different aspects of the product to the shopper. The first illuminated element communicates the brand name of the product while the second element communicates a product performance attribute such as cleaning or whitening capability.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

All examples provided in the Detailed Description of the Invention, and all, listings of aspects of the respective elements and embodiments in the description are to be considered as non-limiting in scope.

All documents cited in the Detailed Description of the Invention are, in relevant part, incorporated herein by reference; the citation of any document is not to be construed as an admission that it is prior art with respect to the present invention. To the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A kit for the merchandising of a product or service, the kit comprising:
(a) a first perceived-as-three dimensional image comprising a directional preference and an indicia associated with the product or service
(b) a display element associated with the product or service.

2. The kit according to claim 1 further comprising a second image associated with the product or service.

3. The kit according to claim 1 wherein the first perceived-as-three-dimensional image comprises at least a portion of an image of the product package.

4. The kit according to claim 1 wherein at least a portion of the first perceived-as-three-dimensional image is perceived to lie below or above the plane of the image.

5. The kit according to claim 1 wherein the at least a portion of the first perceived-as-three-dimensional image is perceived to transition from a first plane perceived to lie at a first location selected from the group consisting of: below the plane of the image, the plane of the image and above the plane of the image to a second plane perceived to lie at a second location selected from that group.

6. The kit according to claim 1 wherein the image comprises information associated with a product or service brand name.

7. The kit according to claim 1 comprising a third image associated with the product or service, wherein the third image is conditionally provided to a purchaser of the product or service

8. The kit according to claim 1 comprising an image system, the image system comprising the first perceived-as-three dimensional image, and a fourth image, wherein the first perceived-as-three-dimensional image corresponds to a first viewer orientation and the fourth image corresponds to a second viewer orientation.

9. A system for the merchandising of a product or service, the system comprising:
(a) a first perceived-as-three-dimensional image comprising a directional preference and an indicia associated with the product or service, the indicia disposed upon a floor surface,
(b) a display element associated with the product or service disposed at a first position upon a displaying element,
wherein the directional preference of the first perceived-as-three dimensional image relates to the location of the display element upon the displaying element.

10. The system according to claim 9 further comprising a second image associated with the product or service.

11. The system according to claim 9 wherein the second image is disposed at a second location upon the displaying element, wherein the display element at the first position at least partially occludes the second image.

12. The system according to claim 9 wherein the first perceived-as-three-dimensional image comprises at least a portion of an image of the product package.

13. The system according to claim 9 wherein at least a portion of the first perceived-as-three-dimensional image is perceived to lie below or above the plane of the image.

14. The system according to claim 9 wherein the directional preference is perceived to transition from a first plane perceived to lie at a first location selected from the group consisting of below the plane of the image, the plane of the image and above the plane of the image to a second plane perceived to lie at a second location selected from that group.

15. The system according to claim 9 wherein the indicia comprises information associated with the product or service brand name.

16. The system according to claim 9 comprising a third image associated with the product or service, wherein the third image is conditionally provided to a purchaser of the product or service.

17. The system according to claim 9 comprising an image system, the image system comprising the first perceived-as-three dimensional image, and a fourth image, wherein the first perceived-as-three-dimensional image corresponds to a first viewer orientation and the fourth image corresponds to a second viewer orientation.

18. An in-store method for merchandising a product or service, the method comprising steps of:
(a) displaying a perceived-as-three-dimensional image upon a floor surface of a merchandising area wherein the image comprises a directional preference,
(b) disposing a display element associated with the product or service at a first location upon a displaying element wherein the displaying element is disposed at a location related to the directional preference,
(c) associating at least a portion of the image with the product or service or an attribute of the product of the product or service.

19. The method according to claim 18, comprising the step of providing a second image associated with the product or service at a second location upon the displaying element, wherein the disposition of the display element at the first location occludes the second image.

20. The method according to claim 18, comprising the step of conditionally providing a third image, comprising a perceived as three dimensional image and an indicia associated with the product or service, to a purchaser of the product or service.
